(19) United States
(12) Patent Application Publication
(10) Pub. No.: US 2026/0031907 A1
(43) Pub. Date: Jan. 29, 2026

(54) SIGNAL PROCESSING APPARATUS, SIGNAL PROCESSING METHOD AND PROGRAM

(71) Applicant: NIPPON TELEGRAPH AND TELEPHONE CORPORATION, Tokyo (JP)

(72) Inventors: Koki SHIBAHARA, Musashino-shi (JP); Megumi HOSHI, Musashino-shi (JP); Yutaka MIYAMOTO, Musashino-shi (JP)

(73) Assignee: NIPPON TELEGRAPH AND TELEPHONE CORPORATION, Tokyo (JP)

(21) Appl. No.: 19/099,984

(22) PCT Filed: Aug. 4, 2022
(86) PCT No.: PCT/JP2022/029930

§ 371 Date: Jan. 30, 2025

(51) Int. Cl. H04B 10/2507; H04B 10/40; H04B 10/50

(52) U.S. Cl. CPC H04B 10/2507; H04B 10/40; H04B 10/50

(57) ABSTRACT

A signal processing device includes a control unit that converts an electrical signal representing a bit string into an optical signal representing a bit string, and removes crosstalk of an n-th main digital signal based on the n-th main digital signal that is a signal transmitted by an n-th transmitter (n is an integer from 1 to N) and a symbol string represented by a result of decoding an optical signal transmitted by at least some of a first transmitter to an N-th transmitter, excluding the n-th transmitter among signals in which the optical signals transmitted by the first transmitter to the N-th transmitter (N is an integer greater than or equal to 2) that transmit the optical signals obtained by conversion and which propagate through a multi core fiber are converted into digital electrical signals

### TECHNICAL FIELD

The present invention relates to a signal processing apparatus, a signal processing method, and a program.

### BACKGROUND ART

With the recent start of 5th generation (5G) services, distribution of high definition moving picture services, enhancement of Internet of Things (IoT) services, and the like, communication traffic flowing through optical networks has been increasing year by year. As countermeasures to the increasing communication traffic demands in optical networks, for example, countermeasures such as improvement of functions of optical communication system apparatuses installed at terminal stations of optical networks and introduction of optical amplification units and optical switches without changing the structure of optical fibers as transmission lines have been taken.

Except for short-distance local networks such as local area network (LAN), single mode fibers (SMFs) are used as the optical fibers that form the basis of current large-capacity optical networks. A single mode fiber has a single core serving as a path for an optical signal in a clad and is an optical fiber that is designed to allow only single mode propagation in wavelength bands such as a C band and an L band used in large capacity optical networks. Accordingly, a large capacity optical network for stably transmitting a large amount of information reaching several terabits per second over a long distance is realized.

In such an optical network, a digital coherent transmission technology using a digital signal processing technology and a coherent transmission/reception technology has been commercially introduced into an optical communication system of 100 gigabits per second. The digital coherent transmission technology is a technology in which a coherent reception method and ultra-high-speed digital signal processing are combined. The coherent reception method is a reception method for detecting coherent light between light on a reception side and local oscillation light. The ultra-high-speed digital signal processing is processing for removing noise of phase components caused by frequency and phase fluctuations in a transmission-side light source for generating signal light and a reception-side light source for generating local oscillation light after digitalizing a signal.

According to the digital coherent transmission technology, a small-sized, inexpensive optical transmission/reception module with low power consumption and an optical transceiver using the same are realized without using a complicated phase-locked circuit or the like. With the advent of digital coherent transmission technology, it is possible not only to improve reception sensitivity at the time of optical transmission constituting a large capacity optical network but also to remarkably enhance information transmission efficiency by loading information on the amplitude, phase and polarized waves of optical carriers.

In recent years, however, the transmission capacity has come close to the theoretical limit of the transmission capacity that an SMF can provide with the improvement of information transmission efficiency. Therefore, attention has been focused on a spatial division multiplex transmission technique in which a transmission medium is rebuilt into an optical fiber having a new structural form called a spatial multiplex optical fiber and different independent information is placed on propagation light in each degree of spatial freedom in the optical fiber.

As an aspect example of the spatial multiplex optical fiber, for example, a multi core fiber (MCF) in which a plurality of cores are arranged in a clad is known. If the cores of the MCF are independent transmission paths arranged in parallel, the transmission capacity per optical fiber is expected to greatly improve.

### CITATION LIST

### Non Patent Literature

[NPL 1] S. Luis, B. J. Puttnam, G. Rademacher, Y. Awaji and N. Wada, “On the Use of High-Order MIMO for Long-Distance Homogeneous Single-Mode Multicore Fiber Transmission”, 2017 European Conference on Optical Communication (ECOC), paper Th2.F2, 2017

### SUMMARY OF INVENTION

### Technical Problem

However, in such an optical transmission system using an MCF, a performance restriction factor which has not been found in an SMF which is an existing transmission medium is actualized. For example, in a case where an optical signal is input to each core of an MCF, phase matching occurs between adjacent cores due to unintended optical fiber cable laying environmental conditions such as bending and vibration, and there may occur an event that optical signals propagating between different cores interfere with each other. That is, in an optical transmission system using an MCF, crosstalk between cores may occur. This phenomenon is called inter-core crosstalk (IXT).

IXT statistically behaves as white noise between optical signals modulated at a modulation rate of about several tens of GBaud, and has cumulative characteristics with transmission distance. Therefore, IXT is a performance restriction factor that deteriorates the signal-to-noise ratio of an optical signal in an optical transmission system together with noise derived from spontaneous emission light generated in optical amplification processing. Therefore, IXT limits the transmission capacity that can be provided by the spatial multiplex transmission line.

It has been reported that IXT can be partially compensated for by applying multiple-input multiple-output (MIMO) techniques widely used in wireless systems (see NPL 1).

However, in the proposal, it is assumed that the optical phases between the optical transceivers and receivers for different cores are synchronized. Further, in the proposal, the configuration of an interface for transferring a reception signal of an optical signal propagated through a different core between signal processing devices for processing a reception signal on the receiving side is assumed to be implicit. Therefore, when the throughput requirement characteristics of optical signals exceeding 100 gigabits per second are determined, the proposed technique is not easy to realize.

In view of the above circumstances, an object of the present invention is to provide a technique for increasing the transmission capacity in an optical transmission system.

### Solution to Problem

One aspect of the present invention is a signal processing device comprising: a control unit that removes crosstalk of an n-th main digital signal based on the n-th main digital signal and a symbol string represented by a result of decoding an optical signal transmitted by at least some of a first transmitter to an N-th transmitter (N is an integer greater than or equal to 2) excluding the n-th transmitter; where the first transmitter to the N-th transmitter are transmitters which convert an electrical signal representing a bit string into an optical signal representing a bit string and transmit the optical signal obtained by the conversion, and where the n-th main digital signal is a signal transmitted by an n-th transmitter (n is an integer from 1 to N) among digital electrical signals obtained by converting the optical signals which is transmitted by the first transmitter to the N-th transmitter and which propagate through a multi core fiber.

One aspect of the present invention is a signal processing method including a control step of removing crosstalk of an n-th main digital signal based on the n-th main digital signal and a symbol string represented by a result of decoding an optical signal transmitted by at least some of a first transmitter to an N-th transmitter (N is an integer greater than or equal to 2) excluding the n-th transmitter; where the first transmitter to the N-th transmitter are transmitters which convert an electrical signal representing a bit string into an optical signal representing a bit string and transmit the optical signal obtained by the conversion, and where the n-th main digital signal is a signal transmitted by an n-th transmitter (n is an integer from 1 to N) among digital electrical signals obtained by converting the optical signals which is transmitted by the first transmitter to the N-th transmitter and which propagate through a multi core fiber.

One aspect of the present invention is a program for causing a computer to function as the signal processing device described above.

### Advantageous Effects of Invention

The present invention makes it possible to increase a transmission capacity of an optical transmission system.

### BRIEF DESCRIPTION OF DRAWINGS

FIG. 1 is an explanatory diagram illustrating an overview of an optical transmission system of an embodiment.

FIG. 2 is a diagram illustrating an example of a configuration of an optical transmitter in the embodiment.

FIG. 3 is a diagram illustrating an example of a configuration of a signal processing unit in the embodiment.

FIG. 4 is a diagram illustrating an example of a hardware configuration of a signal processing device in the embodiment.

FIG. 5 is a flowchart illustrating an example a flow of processing executed by the signal processing device in the embodiment.

FIG. 6 is a first diagram illustrating an example of experimental results using the signal processing device in the embodiment.

FIG. 7 is a second diagram illustrating an example of experimental results using the signal processing device in the embodiment.

### DESCRIPTION OF EMBODIMENTS

### Embodiment

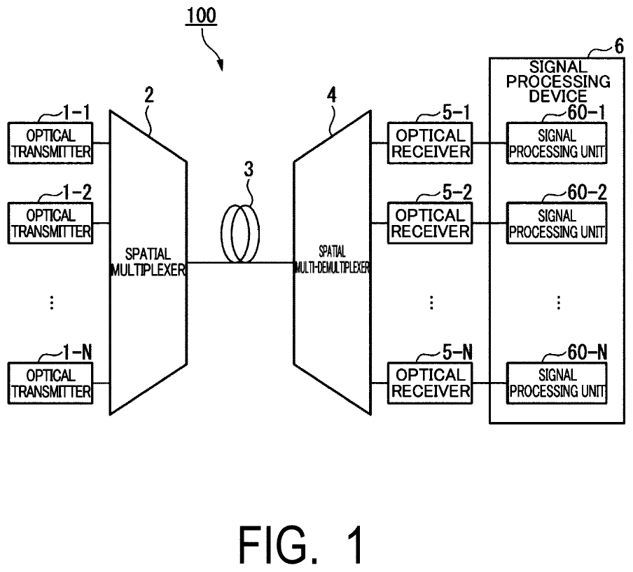

FIG. 1 is an explanatory diagram illustrating an overview of an optical transmission system 100 of an embodiment. The optical transmission system 100 includes optical transmitters 1-1 to 1-N (N is an integer of 2 or more), a spatial multiplexer 2, a multi core fiber (MCF) 3, a spatial multi-demultiplexer 4, optical receivers 5-1 to 5-N, and a signal processing device 6. The optical transmission system 100 may be a system for performing wavelength multiplexing or a system that does not perform wavelength multiplexing.

The optical transmitter 1-n (n is an integer of 1 or more and N or less) converts an electric signal representing a bit string into an optical signal representing a bit string, and transmits the optical signal obtained by the conversion. Therefore, the optical transmitter 1-n (n is an integer of 1 or more and N or less) transmits the bit string. Hereinafter, a bit string to be converted by the optical transmitter 1-n is referred to as a bit string b-n. Therefore, for example, the optical transmitter 1-1 converts an electric signal representing a bit string b-1 into an optical signal representing a bit string b-1.

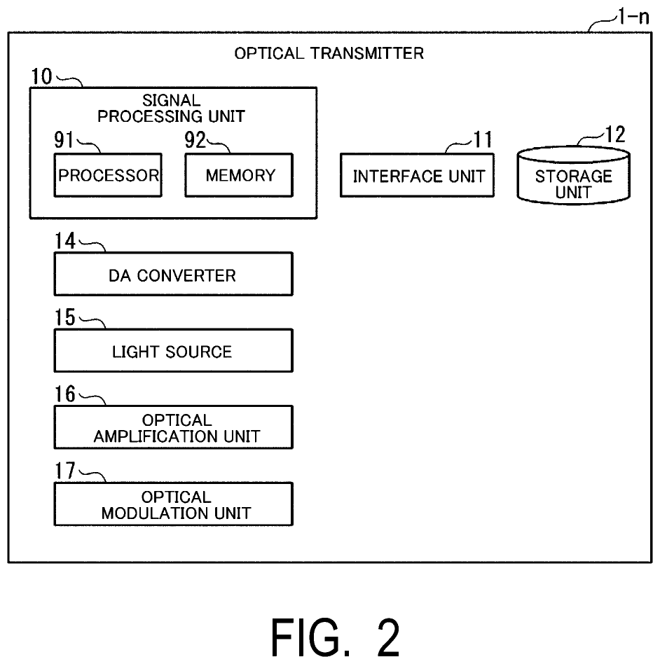

FIG. 2 is a diagram illustrating an example of the configuration of the optical transmitter 1-n in the embodiment. The optical transmitter 1-n includes a signal processing unit 10 including a processor 91 such as a central processing unit (CPU) and a memory 92, which are connected by a bus, and executes a program. The optical transmitter 1-n functions as a device including the signal processing unit 10, an interface unit 11, a storage unit 12, a DA converter 14, a light source 15, an optical amplification unit 16, and an optical modulation unit 17.

More specifically, the processor 91 reads out the program stored in the storage unit 12, and stores the read program in the memory 92. By the processor 91 executing the program stored in the memory 92, the optical transmitter 1-n functions as a device including the signal processing unit 10, the interface unit 11, the storage unit 12, the DA converter 14, the light source 15, the optical amplification unit 16, and the optical modulation unit 17.

The signal processing unit 10 controls the operation of each functional unit of the optical transmitter 1-n. The signal processing unit 10 outputs an electric signal representing a bit string to the DA converter 14.

The interface unit 11 is configured to include an interface for connecting the optical transmitter 1-n to an external device. The interface unit 11 communicates with an external device through wired or wireless connection. The external device is, for example, a user terminal. In such a case, for example, information indicating a bit string to be transmitted to the optical transmitter 1-n is input from the user terminal to the interface unit 11. The signal processing unit 10 acquires information indicating a bit string input to the interface unit 11 (hereinafter referred to as “bit string information”). The signal processing unit 10 outputs an electric signal of a bit string indicated by the acquired bit string information.

A signal for synchronizing the initial phase of the optical signals transmitted by the optical transmitters 1-1 to 1-N may be input to the interface unit 11. In a case where such a signal is input to the interface unit 11, the initial phases of the optical signals transmitted by the optical transmitters 1-1 to 1-N are synchronized.

A signal for synchronizing the clocks of the optical transmitters 1-1 to 1-N may be input to the interface unit 11. In a case where such a signal is input to the interface unit 11, the clocks of the optical transmitters 1-1 to 1-N are synchronized. The synchronization of the clocks of the optical transmitters 1-1 to 1-N means that the clocks of the signal processing unit 10 and the DA converter 14 provided in the optical transmitters 1-1 to 1-N are synchronized.

The storage unit 12 is configured using a non-transitory computer-readable recording medium such as a magnetic hard disk device or a semiconductor storage device. The storage unit 12 stores various types of information on the optical transmitter 1-n.

The DA converter 14 is a digital-to-analog converter for converting the digital electric signal output from the signal processing unit 10 into an analog electric signal. The digital electric signal is a signal which is both an electric signal and a digital signal. In addition, an analog electric signal is a signal which is both an electric signal and an analog signal. The digital electric signal output from the signal processing unit 10 is specifically an electric signal of a bit string.

The light source 15 is a light source that emits directional light. The light source 15 is, for example, a semiconductor laser. The light source 15 is independently controlled between the optical transmitters, and emits continuous light in a free-run state.

The optical amplification unit 16 amplifies the light emitted from the light source 15. The optical modulation unit 17 modulates the light amplified by the optical amplification unit 16 based on the analog digital signal obtained by the DA converter 14, and generates an optical signal representing a bit string indicated by bit string information input to the interface unit 11. The optical modulation unit 17 transmits the generated optical signal to the outside of the optical transmitter 1-n. Thus, the optical signal transmitted by the optical modulation unit 17 is emitted from the optical transmitters 1-1 to 1-N.

Returning to the explanation of FIG. 1. The optical signals emitted from the optical transmitters 1-1 to 1-N are made incident on the spatial multiplexer 2.

The spatial multiplexer 2 receives the optical signals emitted from the optical transmitters 1-1 to 1-N, respectively. The optical signal received by the spatial multiplexer 2 is incident on the multi core fiber 3. That is, the spatial multiplexer 2 performs spatial multiplexing of the optical signal.

The multi core fiber 3 is a multi core fiber through which an incident optical signal propagates. The optical signal propagated through the multi core fiber 3 is made incident on the spatial multi-demultiplexer 4. The multi core fiber 3 is, for example, a spatial multiplex fiber capable of propagating N spatial channels. The multi core fiber 3 may be, for example, a spatial multiplex fiber having an allowable number of spatial channels of M (M<N, M is an integer).

The spatial multi-demultiplexer 4 receives the optical signal emitted from the multicore fiber 3. The optical signal received by the spatial multi-demultiplexer 4 is made incident on optical receivers 5-1 to 5-N. Therefore, the spatial multi-demultiplexer 4 divides the spatially multiplexed optical signal.

Each of the optical receivers 5-1 to 5-N receives the optical signal passing through the multi core fiber 3. More specifically, the optical receiver 5-n receives the signal transmitted by the optical transmitter 1-n.

Meanwhile, interference (coupling) occurs between spatial channels by satisfying the phase matching conditions during propagation of the multi core fiber 3 between optical signals during propagation of the multi core fiber 3. For example, a transmission signal x-n emitted from the optical transmitter 1-n receives the crosstalk of an optical signal x-p emitted from the other optical transmitter 1-p (p is an integer of 1 or more and N or less and different from n). Therefore, the optical signal received by the optical receiver 5-n is an optical signal which receives crosstalk of signals transmitted by other optical transmitters 1-p other than the optical transmitters 1-n.

In this way, in the optical transmission system 100, the optical signal transmitted by the optical transmitter 1-n and affected by crosstalk is received by the optical receiver 5-n.

Each of the optical receivers 5-1 to 5-N converts the received optical signal into an analog electrical signal and outputs the signal to the signal processing device 6.

Therefore, in the optical transmission system 100, the optical signal transmitted by the optical transmitter 1-n and affected by crosstalk is converted into an analog electric signal by the optical receiver 5-n. In the optical transmission system 100, the electric signal obtained by the conversion by the optical receiver 5-n is propagated to the signal processing device 6.

The signal processing device 6 includes a control unit including a processor such as a CPU and a memory connected through a bus and a storage unit, and executes a program. The signal processing device 6 acquires each electric signal output from the optical receivers 5-1 to 5-N.

The signal processing device 6 includes signal processing units 60-1 to 60-N. Hereinafter, in a case where the signal processing units 60-1 to 60-N are not distinguished from each other, it referred to as signal processing units 60.

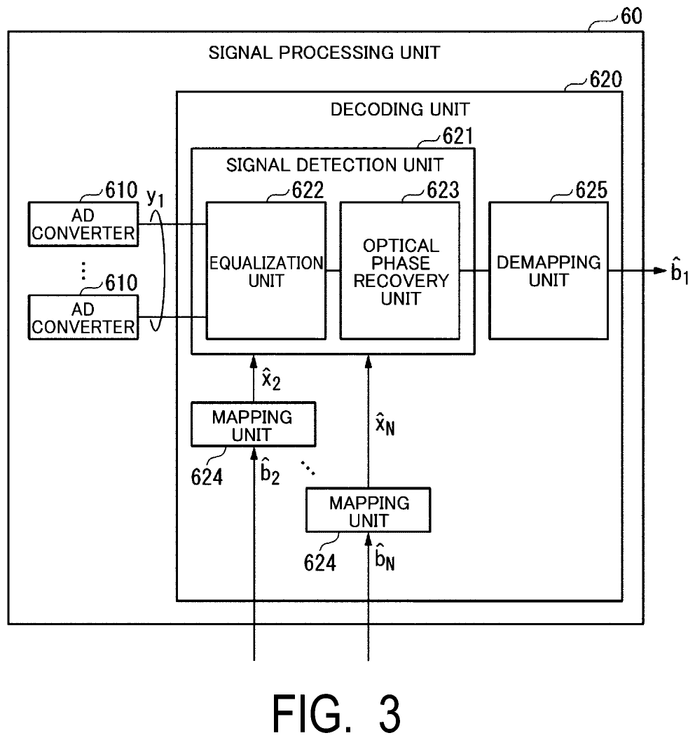

FIG. 3 is a diagram illustrating an example of a configuration of a signal processing unit 60 in the embodiment. The signal processing unit 60 includes an analog-to-digital (AD) converter 610. The AD converter 610 acquires the analog electrical signal propagated to the signal processing device 6 and converts the electrical signal into a digital signal. That is, the signal processing device 6 includes the AD converter 610, and converts an analog electric signal propagated to its own device into a digital signal. In the example illustrated in FIG. 3, four AD converters XI, XQ, YI and YQ are used in one spatial channel. Therefore, in the example of FIG. 3, the number of AD converters 610 is 4 N.

The signal processing unit 60 includes a decoding unit 620. The decoding unit 620 includes a control unit included in the signal processing device 6. The decoding unit 620 executes estimation signal generation processing. The estimation signal generation processing is processing for estimating a bit string transmitted by the optical transmitter 1-n based on the n-th main digital signal and generating an electric signal representing the estimated bit string. That is, the estimation signal generation processing is processing for generating an electric signal representing the estimation result of the bit string transmitted by the optical transmitter 1-n based on the n-th main digital signal. Therefore, the estimation signal generation processing is processing for decoding the optical signal transmitted by the optical transmitter 1-n and estimating the bit string represented by the optical signal.

The n-th main digital signal is a signal obtained by converting an analog electric signal obtained by conversion by the optical receiver 5-n into a digital signal by the AD converter 610. Therefore, for example, the first main digital signal is a signal obtained by converting an analog electric signal obtained by the conversion by the optical receiver 5-1 into a digital signal by the AD converter 610. Therefore, the n-th digital signal is an electric digital signal.

Hereinafter, an electric signal representing the estimation result of the bit string transmitted by the optical transmitter 1-n is referred to as an n-th estimation signal. Therefore, for example, the first estimation signal is an electric signal representing the estimation result of the bit string transmitted by the optical transmitter 1-1. Since the n-th estimation signal is an electric signal representing the estimation result of the bit string, it is an electric signal representing the bit string. If the estimation signal generation process is explained using the word called the n-th estimation signal, the estimation signal generation processing is processing for generating the n-th estimation signal based on the n-th main digital signal.

Signals represented by b₁, b₂ and b_{N} in which hat (\hat{ }) in FIG. 3 is attached as accent symbols are respectively an example of a first estimation signal, a second estimation signal, and the N-th estimation signal.

Since the estimation signal generation processing is processing for generating an n-th estimation signal based on the n-th main digital signal, the n-th estimation signal is a result of decoding a bit string transmitted by the optical transmitter 1-n.

The decoding unit 620 includes a signal detection unit 621, a mapping unit 624, and a demapping unit 625. The signal detection unit 621 includes an equalization unit 622 and an optical phase recovery unit 623.

The equalization unit 622 executes equalization processing. The equalization processing is processing of estimating the intensity of interference between the optical signal transmitted by the optical transmitter 1-n and the optical signal transmitted by at least a part of the optical transmitters 1-1 to 1-N except the optical transmitter 1-n based on the optical signal transmitted by the optical transmitter 1-n and the auxiliary symbol string. The auxiliary symbol string is a symbol string represented by a decoding result of an optical signal transmitted by at least a part of the optical transmitters 1-1 to 1-N except the optical transmitter 1-n. Therefore, the auxiliary symbol string may be, for example, a bit string generated by another signal processing unit 60 by the estimation signal generation processing.

Since waveform distortion or polarization rotation occurs due to interference between the optical signal transmitted by the optical transmitter 1-n and the optical signal transmitted by the other optical transmitter 1-p, the magnitude of interference between the optical signal transmitted by the optical transmitter 1-n and the optical signal transmitted by the other optical transmitter 1-p is the magnitude of waveform distortion or polarization rotation. The equalization processing is, for example, the processing described in Reference Literature 1 below.
Reference Literature 1: K. Shibahara et al., “Iterative Unreplicated Parallel Interference Canceler for MDL-Tolerant Dense SDM (12-Core×3-Mode) Transmission Over 3000 km,” in Journal of Lightwave Technology, vol. 37, No. 6, pp. 1560-1569, 2019.

An optical phase recovery unit 623 executes optical phase recovery processing. The optical phase recovery processing is processing of estimating phase noise included in an n-th main digital signal to be processed based on an optical signal transmitted by the optical transmitter 1-n and a symbol string represented by the result of decoding the optical signal transmitted by at least some of the optical transmitters 1-1 to 1-N, excluding optical transmitter 1-n. Specifically, the signal to be processed by the optical phase recovery processing is an n-th main digital signal. The optical phase recovery processing is, for example, processing described in Reference Literature 2 below.
Reference Literature 2: Kohki Shibahara, Takayuki Mizuno, and Yutaka Miyamoto, “MIMO carrier phase recovery for carrier-asynchronous SDM-MIMO reception based on the extended Kalman filter,” Opt. Express 29, PP. 17111-17124, 2021.

The equalization processing described in Reference Document 1 and the optical phase recovery processing described in Reference Literature 2 will be described using equations with reference to the case where the signal of the object to be equalized is the first main digital signal as an example. In a case where initial phases of optical signals transmitted by the optical transmitters 1-1 to 1-N are synchronized, the first main digital signal is y₁ expressed by Equation (1) below, for example.

$$\begin{matrix}[ Math . 1 ] & \\ {y}_{1} = {h}_{11} {x}_{1} {e}^{j ( {φ}_{1}^{t} + {φ}_{1}^{r} )} + {\sum }_{i = 2}^{{N}_{t}} {h}_{1 i} {x}_{i} {e}^{j ( {φ}_{1}^{t} + {φ}_{1}^{r} )} + {n}_{1} & ( 1 )\end{matrix}$$

hᵢⱼ represents a channel matrix component corresponding to a path from the optical transmitter 1-i to the optical receiver 5-j. Here, i and j are integers greater than or equal to 1 and less than or equal to N. However, j at the shoulder of the exponential function means an imaginary unit. φ^{t}ᵢ represents phase noise of a light source provided in the optical transmitter 1-i. φ^{r}ᵢ represents phase noise of a light source provided in the optical receiver 5-i. nᵢ represents noise superimposed on the reception signal i. The sum of φ^{t}ᵢ and φ^{r}ᵢ is an example of phase noise included in the n-th main digital signal.

The second term on the right side in Equation (1) represents the crosstalk superimposed on the optical signal transmitted by the optical transmitter 1-1. Information for removing crosstalk is obtained by equalization processing and optical phase recovery processing based on a p-th estimation signal which is an output signal from a signal processing unit 60-p (p not equal to 1). More specifically, h₁ᵢ is estimated in the equalization processing, and the value of an exponential function whose shoulder is j(φ^{t}ᵢ+φ^{r}ᵢ) in the second term of Equation (1) is estimated in the optical phase recovery processing. hᵢⱼ represents the magnitude of interference between the optical signal transmitted by the optical transmitter 1-i and the optical signal transmitted by the other optical transmitter 1-j.

Crosstalk can be removed when using hᵢⱼ estimated by the equalization processing and the optical phase recovery processing and a value of an exponential function whose shoulder is j(φ^{t}ᵢ+φ^{r}ᵢ) in the second term of Equation (1).

Then, the signal detection unit 621 removes crosstalk from the n-th main digital signal to be processed using h₁ᵢ and the value of an exponential function whose shoulder is j(φ^{t}ᵢ+φ^{r}ᵢ) in the second term of Equation (1). Hereinafter, the processing for setting the object to be processed as the n-th main digital signal, and the processing for removing the crosstalk of the object to be processed based on the results of the equalization processing and the optical phase recovery processing is referred to as a removal processing.

In this way, the signal detection unit 621 executes equalization processing, optical phase recovery processing, and removal processing. As a result of the removal processing, the n-th main digital signal from which the crosstalk is removed is obtained.

The optical phase recovery processing may be, for example, processing described in Reference Literature 3 below.
Reference Literature 3: T. Pfau, S. Hoffmann, and R. Noe, “Hardware-Efficient Coherent Digital Receiver Concept With Feedforward Carrier Recovery for M-QAM Constellations,” Journal of Lightwave Technology vol. 27, No. 8, pp. 989-999, 2009.

The equalization processing described in Reference Literature 1 and the optical phase recovery process described in Reference Literature 3 will be described using equations with reference to the case where the signal of the object to be equalized is the first main digital signal as an example. In a case where initial phases of optical signals transmitted by the optical transmitters 1-1 to 1-N are not synchronized, the first main digital signal is y₁ expressed by Equation (2) below, for example.

$$\begin{matrix}[ Math . 2 ] & \\ {y}_{1} = {h}_{11} {x}_{1} {e}^{j ( {φ}_{1}^{t} + {φ}_{1}^{r} )} + {\sum }_{i = 2}^{{N}_{t}} {h}_{1 i} {x}_{i} {e}^{j {φ}_{1}} + {n}_{1} & ( 2 )\end{matrix}$$

In the above expression, φ₁ is a quantity defined by Equation (3) below. φ₁ is given in a simple form due to phase synchronization of a light source provided in the optical transmitter.

$$\begin{matrix}[ Math . 3 ] , & \\ {φ}_{1} {=}^{Δ} {φ}_{1}^{t} + {φ}_{1}^{r} & ( 3 )\end{matrix}$$

The second term on the right side of Equation (3) represents the crosstalk superimposed on the optical signal transmitted by the optical transmitter 1-1. Information for removing crosstalk is obtained by equalization processing and optical phase recovery processing based on a p-th estimation signal which is an output signal from a signal processing unit 60-p (p not equal to 1).

More specifically, h₁ᵢ is estimated in the equalization processing, and the value of an exponential function whose shoulder is jφ₁ is estimated in the optical phase recovery processing. The signal detection unit 621 obtains the n-th main digital signal from which crosstalk has been removed using h₁ᵢ estimated by the equivalent processing and the value of the exponential function whose shoulder is jφ₁, estimated by the optical phase recovery processing by executing the removal processing on the n-th main digital signal.

The mapping unit 624 executes mapping processing on the processing object. The mapping processing is processing of a bit string as a processing object, and converting the bit string of the processing object into a symbol string. The symbol string obtained by the conversion is an example of an auxiliary symbol string. The symbol string input to the equalization unit 622 is the output of the mapping unit 624. Therefore, the mapping unit 624 receives another bit string of the conversion source of the symbol string used for the equalization processing and the optical phase recovery processing. The input bit string is a processing object of the mapping processing.

In FIG. 3, both signals x₂ and x_{N} in which hat (\hat{ }) is attached as accent symbols are examples of auxiliary symbol strings. x₂ to which the hat (\hat{ }) is attached as an accent symbol is an auxiliary symbol string obtained as a result of mapping processing with the second estimation signal as a processing object. x_{N} to which the hat (\hat{ }) is attached as an accent symbol is an auxiliary symbol string obtained as a result of mapping processing with the N-th estimation signal as a processing object. In the example illustrated in FIG. 3, the number of mapping units 624 is N−1.

The demapping unit 625 executes demapping processing. The demapping processing is processing of converting a processing object into a bit string. A processing object of the demapping processing is an n-th main digital signal from which crosstalk is removed by the removal processing. The signal obtained by the demapping processing is a bit string represented by a signal obtained by removing crosstalk from the n-th main digital signal. Therefore, the signal obtained by the demapping processing is an electric signal representing the estimation result of the bit string transmitted by the optical transmitter 1-n.

An electric signal representing the estimation result of the bit string transmitted by the optical transmitter 1-n is obtained based on the n-th main digital signal by equalization processing, optical phase recovery processing, removal processing, and demapping processing. Therefore, the equalization processing, the optical phase recovery processing, the removal processing, and the demapping processing are processing included in the estimation signal generation processing.

The mapping processing is not necessarily executed if the symbol string obtained by the mapping processing can be used in the equalization processing and the optical phase recovery processing. In a case where the mapping processing is executed, the mapping processing is also processing included in the estimation signal generation processing.

Thus, in the estimation signal generation processing, the bit string converted from the electric signal to the optical signal by the optical transmitter 1-n is estimated using the auxiliary symbol string instead of a high-speed analog signal or a quantized digital signal. That is, in the estimation signal generation processing, a bit string converted from an electric signal to an optical signal by the optical transmitter 1-n is estimated without need to satisfy the first and second prerequisites.

The first precondition is a condition that the optical phases between the optical transceivers for different cores are synchronized. The second precondition is a condition that an interface for transferring a reception signal of an optical signal propagated through a different core is configured between signal processing devices for processing a reception side signal.

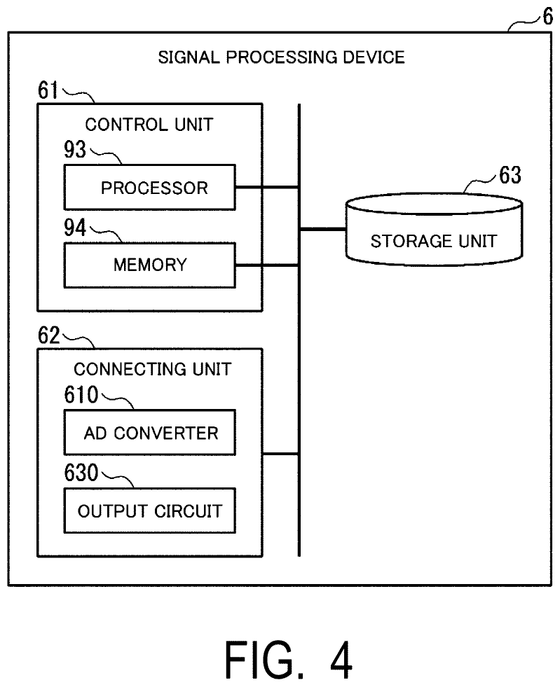

FIG. 4 is a diagram illustrating an example of a hardware configuration of the signal processing device 6 in the embodiment. The signal processing device 6 includes a control unit 61 including a processor 93 such as a CPU and a memory 94, which are connected by a bus, and executes a program. The signal processing device 6 functions as a device including the control unit 61, a connection unit 62, and a storage unit 63 by executing a program.

More specifically, the processor 93 reads the program stored in the storage unit 63, and stores the read program in the memory 94. The processor 93 executes the program stored in the memory 94, so that the signal processing device 6 functions as a device including the control unit 61, the connection unit 62, and the storage unit 63.

The control unit 61 controls operations of various functional units included in the signal processing device 6. The control unit 61 includes the decoding unit 620. Therefore, the control unit 61 executes, for example, estimation signal generation processing. That is, the control unit 61 removes the crosstalk of the n-th main digital signal based on an n-th main digital signal of the optical signals transmitted by the optical transmitters 1-1 to 1-N and propagated through the multi-core fiber 3, which are converted into digital electrical signals and the auxiliary symbol string.

The connection unit 62 includes an AD converter 610. Therefore, the connection unit 62 is connected to the optical receivers 5-1 to 5-N and generates an n-th main digital signal. The connection unit 62 includes an output circuit 630 that is a circuit connected to an output destination of the signal output by the estimation signal generation processing. Therefore, the connection unit 62 is connected to the output destination of the signal output by the estimation signal generation processing.

The storage unit 63 is configured using a non-transitory computer-readable recording medium such as a magnetic hard disk device or a semiconductor storage device. The storage unit 63 stores various types of information regarding the signal processing device 6. The storage unit 63 stores a bit string represented by an n-th estimation signal obtained by, for example, estimation signal generation processing.

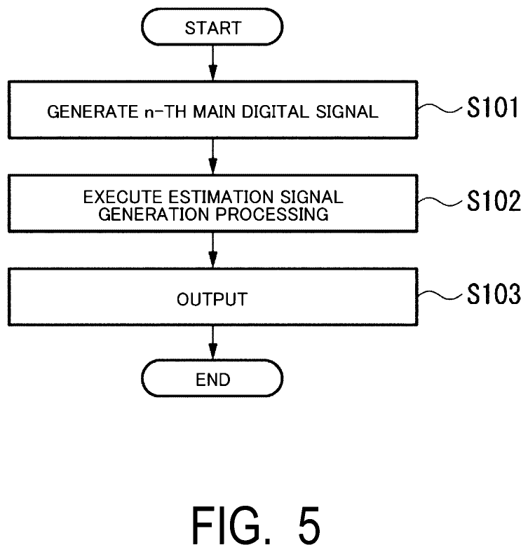

FIG. 5 is a flowchart illustrating an example a flow of processing executed by the signal processing device 6 in the embodiment. The connection unit 62 generates the n-th main digital signal (step S101). Next, the control unit 61 executes estimation signal generation processing to the n-th main digital signal (step S102). Next, the control unit 61 outputs the result of the estimation signal generation processing in step S102 (step S103).

### Experimental Results

Examples of experimental results using the signal processing device 6 in the embodiment will be explained. In the experiment, signal transmission simulation was performed. In the experiment, the number of optical transmitters and optical receivers in the optical transmission system 100 was two for both. In the experiment, a 16 QAM signal with a modulation rate of 10 GBaud was generated and received. Both the line widths of the light source of the optical transmitter and the light source of the optical receiver were 100 kHz.

In experiments, crosstalk between one signal and the other signal propagating through the multicore fiber 3 was 15 dB. In the experiment, simulation satisfying the condition that the initial phases of the optical signals transmitted by the optical transmitters 1-1 and 1-2 are not synchronized and simulation satisfying the condition that the initial phases of the optical signals transmitted by the optical transmitters 1-1 and 1-2 are synchronized are performed.

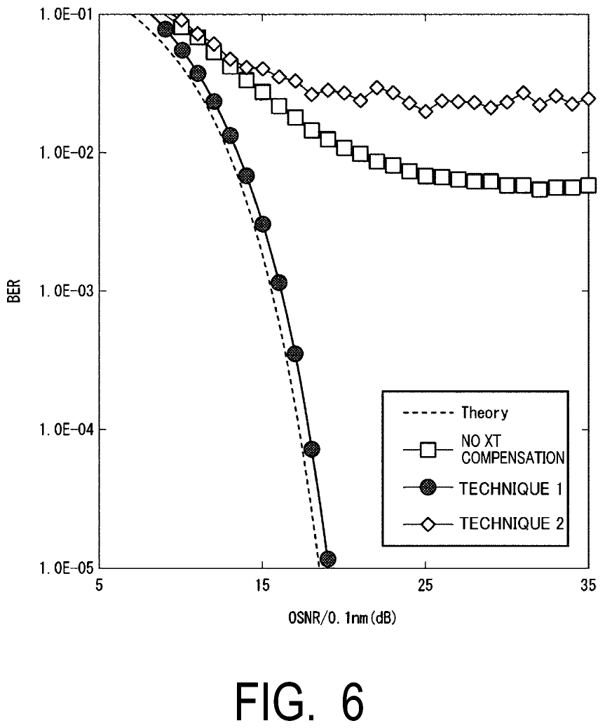

FIG. 6 is a first diagram illustrating an example of experimental results using the signal processing device 6 in the embodiment. More specifically, the result of FIG. 6 is an example of the simulation result satisfying the condition that the initial phases of the optical signals transmitted by the optical transmitters 1-1 and 1-2 are not synchronized.

The vertical axis of FIG. 6 shows the bit error rate of one signal sequence. The horizontal axis indicates the optical signal to noise ratio (OSNR). The “Theory” results show the theoretical results obtained under the assumption that there is no crosstalk. “No XT compensation” results indicate simulation results without crosstalk compensation. The curve of the “Technique 1” indicates the result obtained in a case where the optical phase recovery processing is processing of Reference Literature 2. The curve of “Technique 2” indicates the results obtained in a case where the optical phase recovery processing is that of Reference Literature 3.

In the simulation, a separation matrix whose crosstalk amount is known is used as a matrix having weight coefficients in equalization processing for crosstalk compensation as components.

The results illustrated in FIG. 6 show that in a case where crosstalk compensation is not performed, the crosstalk amount is constant even if the OSNR increases, and therefore the characteristics thereof gradually approach a line having a constant bit error rate. Regarding the crosstalk compensation characteristics of “Technology 2”, the results of FIG. 6 show that the equalization processing increases the crosstalk component because the transmitting side light source optical phases are not synchronized, and the characteristics are worse than the curve without crosstalk compensation.

The results in FIG. 6 show that the results when applying the crosstalk compensation method of “Technology 1” are close to the results of “Theory”. This result indicates that crosstalk can be compensated even in a case where the light phase of the light source on the transmission side is asynchronous.

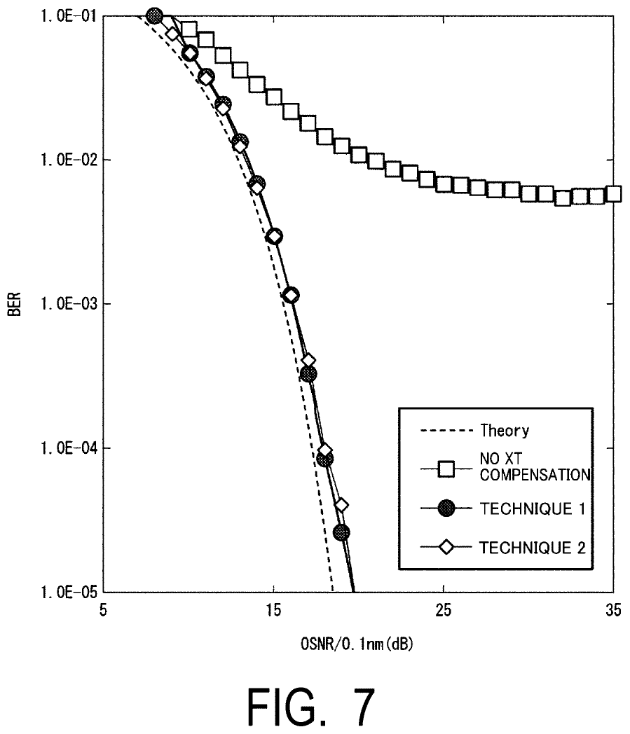

FIG. 7 is a second diagram illustrating an example of experimental results using the signal processing device 6 in the embodiment. The results of FIG. 7 are examples of experimental results satisfying the condition that the initial phases of the optical signals transmitted by the optical transmitters 1-1 to 1-2 are synchronized.

The definitions of “Theory”, “No XT compensation”, “Technology 1”, and “Technique 2” are the same as in FIG. 6. FIG. 7 illustrates that the result in a case of applying the crosstalk compensation method of “Technique 1” is close to the result of “Theory”. Further, FIG. 7 illustrates that since the synchronization condition of the light source optical phase on the transmitting side, the results in a case of applying the crosstalk compensation method of “Technique 2” show characteristics that are generally similar to those obtained by the crosstalk compensation method of “Technique 1”.

The signal processing device 6 thus constituted estimates a bit string converted from an electric signal to an optical signal by the optical transmitter 1-n using an auxiliary symbol string instead of a high-speed analog signal or a quantized digital signal. That is, the signal processing device 6 estimates a bit string converted from an electric signal to an optical signal by the optical transmitter 1-n without the need to satisfy the first and second prerequisites.

Therefore, the signal processing device 6 can reduce the time required for transmitting and receiving the electric signal in the signal processing device 6. Since the transmission capacity of the optical transmission system is also affected by the performance of signal processing by the signal processing device 6, the signal processing device 6 capable of reducing the time required for transmitting and receiving an electric signal in the signal processing device 6 enables communication satisfying the throughput requirement characteristics of an optical signal exceeding 100 gigabit per second. Therefore, the signal processing device 6 can improve the transmission capacity in the optical transmission system.

### Modification Example

The clocks of the optical transmitters 1-1 to 1-N may be synchronized.

The signal processing device 6 may further include a wavelength dispersion compensation unit, a clock recovery unit, or a frequency offset compensation unit. The signal processing unit 10 provided in the optical transmitters 1-1 to 1-N may perform forward error correction encoding to an electric signal representing a bit string. In such a case, the demapping unit 625 performs decoding processing for forward error correction coding.

Each processing in the signal processing units 60-1 to 60-N may be sequentially performed regardless of the order or may be performed in parallel. In a case where processing is performed in parallel, the bit determination error rate is reduced as q increases in the output from the signal processing unit 60-n after q-th (q is a natural number). Specifically, each processing in the signal processing units 60-1 to 60-N is performed by performing equalization processing, optical phase recovery processing, removal processing, mapping processing and demapping processing.

The initial phases of the optical signals transmitted by the optical transmitters 1-1 to 1-N are synchronized, for example, by giving light branched from a single light source to each optical transmitter. The initial phase of the optical signals transmitted by the optical transmitters 1-1 to 1-N is synchronized by locking the optical phase using, for example, a light injection synchronizing laser.

The signal processing device 6 may be implemented using a plurality of information processing devices communicatively connected via a network. In this case, each functional unit included in the signal processing device 6 may be distributed and implemented in the plurality of information processing devices.

The optical transmitter 1-n is an example of an n-th transmitter. Therefore, the optical transmitter 1-1 is an example of the first transmitter, and the optical transmitter 1-N is an example of the N-th transmitter.

All or part of each function of the signal processing device 6 may be implemented using a hardware such as an application specific integrated circuit (ASIC), a programmable logic device (PLD), or a field programmable gate array (FPGA). A program may be recorded in a computer-readable recording medium. The computer-readable recording medium is, for example, a portable medium such as a flexible disk, a magneto optical disk, a ROM, or a CD-ROM, or a storage device such as a hard disk built in a computer system. The program may be transmitted over a telecommunication line.

Although the example of the present invention has been described in detail with reference to the drawings, a specific configuration is not limited to this example, and design within the scope of the gist of the present invention, and the like are included.

### REFERENCE SIGNS LIST

100 Optical transmission system
1-1 to 1-N, 1-n Optical transmitter
10 Signal processing unit
11 Interface unit
12 Storage unit
14 DA converter
15 Light source
16 Optical amplification unit
17 Optical modulation unit
2 Spatial multiplexer
3 Multi core fiber
4 Spatial multi-demultiplexer
5-1 to 5-N Optical receiver
6 Signal processing device
60-1 to 60-N Signal processing unit
610 AD converter
620 Decoding unit
621 Signal detection unit
622 Equalization unit
623 Optical phase recovery unit
624 Mapping unit
625 Demapping unit
61 Control unit
62 Connection unit
630 Output circuit
63 Storage unit
91 Processor
92 Memory
93 Processor
94 Memory

1. A signal processing device comprising:
a first processor;
a first storage medium having computer program instructions stored thereon, wherein the computer program instruction, when executed by the first processor, perform processing of:
removing crosstalk of an n-th main digital signal based on the n-th main digital signal and a symbol string represented by a result of decoding an optical signal transmitted by at least some of a first transmitter to an N-th transmitter (N is an integer greater than or equal to 2) excluding the n-th transmitter;
where the first transmitter to the N-th transmitter are transmitters which convert an electrical signal representing a bit string into an optical signal representing a bit string and transmit the optical signal obtained by the conversion, and
where the n-th main digital signal is a signal transmitted by an n-th transmitter (n is an integer from 1 to N) among digital electrical signals obtained by converting the optical signals which is transmitted by the first transmitter to the N-th transmitter and which propagate through a multi core fiber.

2. The signal processing device according to claim 1,
wherein the processor estimates a magnitude of interference between the optical signal transmitted by the n-th optical transmitter and the optical signal transmitted by a p-th optical transmitter (p is an integer from 1 to N, but different from n) and a phase noise included in the n-th main digital signal based on the n-th main digital signal and the symbol string.

3. The signal processing device according to claim 1,
wherein initial phases of the optical signals output from the first transmitter to the N-th transmitter are synchronized.

4. A signal processing method comprising:
removing crosstalk of an n-th main digital signal based on the n-th main digital signal and a symbol string represented by a result of decoding an optical signal transmitted by at least some of a first transmitter to an N-th transmitter (N is an integer greater than or equal to 2) excluding the n-th transmitter;
where the first transmitter to the N-th transmitter are transmitters which convert an electrical signal representing a bit string into an optical signal representing a bit string and transmit the optical signal obtained by the conversion, and
where the n-th main digital signal is a signal transmitted by an n-th transmitter (n is an integer from 1 to N) among digital electrical signals obtained by converting the optical signals which is transmitted by the first transmitter to the N-th transmitter and which propagate through a multi core fiber.

5. A non-transitory computer readable medium which stores a program for causing a computer to function as the signal processing device according to claim 1.
